(19) United States
(12) Patent Application Publication
(10) Pub. No.: US 2009/0124940 A1
(43) Pub. Date: May 14, 2009

(54) MASSAGE MACHINE

(75) Inventors: Fumihiro Nishio, Hikone-shi (JP); Takayoshi Tanizawa, Higashioumi-shi (JP); Masamichi Miyaguchi, Hikone-shi (JP); Yuichi Nishibori, Hikone-shi (JP); Daisuke Tsukada, Hikone-shi (JP); Satoshi Kajiyama, Hikone-shi (JP); Yousuke Kurata, Hikone-shi (JP); Masatoshi Dairin, Hikone-shi (JP); Munekiyo Ikebe, Hikone-shi (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC WORKS, LTD., Osaka (JP)

(21) Appl. No.: 11/995,861

(22) PCT Filed: Jul. 26, 2006
(86) PCT No.: PCT/JP2006/314745

§ 371 Date: Jan. 16, 2008

(30) Foreign Application Priority Data
Jul. 28, 2005 (JP) 2005-219481
Jul. 28, 2005 (JP) 2005-219482

(51) Int. Cl. A61H 1/00; A61H 7/00

(52) U.S. Cl. 601/49; 601/84; 601/99; 601/134

(57) ABSTRACT

A massage machine comprises a drive shaft rotatably driven in forward and reverse directions; a pair of inclined shafts mounted on both ends of the drive shaft so as to have an arbitrary inclination relative to an axial direction of the drive shaft; a pair of left and right massage ball units including massage balls and rotatably connected to outer peripheral surfaces of the pair of inclined shafts, respectively; and switching means for switching an axial rotation position of one inclined shaft of the pair of inclined shafts. The massage ball units each comprise a swing arm having one end rotatably connected to the outer peripheral surface of the inclined shaft; and a support arm connected to the other end of the swing arm and having mounted thereon multiple massage balls at a vertical distance from each other. Thus, according to the massage machine, the distance from the drive shaft to the massage balls is large because of the presence of the swing arms, while the moving range of the massage balls is large because the upper and lower massage balls mounted on each support arm move in the same direction, so that a person to be treated can have great massage feeling.

### TECHNICAL FIELD

The present invention relates to a massage machine in which massage balls are swung to trace a three-dimensional trajectory so as to perform various treatments such as kneading massage, tapping massage and vibration massage.

### BACKGROUND ART

In the prior art, a massage machine is known which uses the power of a driving unit to swing roller-shaped massage balls so as to massage the back of a person to be treated. As disclosed e.g. in Japanese Laid-open Patent Publication 2003-38591, a massage machine is known which comprises drive shafts rotated by a motor as a power source, and a pair of left and right swing arms arranged inclined to the drive shafts, in which multiple massage balls provided on these swing arms are moved left and right so as to give a kneading massage to the back of a person to be treated.

In the massage machine disclosed in the Japanese Laid-open Patent Publication 2003-38591 described above, the drive shafts are separated between the respective left and right swing arms, and have ends at the separation connected to each other via a half rotation clutch mechanism. The half rotation clutch mechanism allows one drive shaft of the separated drive shafts to idle in a range of substantially half rotation when the drive shaft (sic, correctly: the other drive shaft) is driven to rotate in one rotation method (sic, correctly: one rotation direction), either forward or reverse. This allows the massage machine either to make the inclination directions of the swing arms opposite to each other to perform kneading massage as shown in FIGS. 15A and 15B, or to make the inclination directions of the swing arms parallel to each other to perform swing massage as shown in FIGS. 16A and 16B (sic, correctly: 15C and 15D).

### DISCLOSURE OF INVENTION

However, as shown in FIGS. 15A and 15B and FIGS. 16A and 16B (sic, correctly: 15C and 15D), each swing arm has upper and lower massage balls mounted thereon which always move in opposite directions. Accordingly, the moving range of the massage balls is small. Particularly, in the case of swing massage, sometimes a person to be treated cannot have sufficient massage feeling. Further, the conventional massage machine allows one drive shaft to temporarily idle when switching between the state of swing massage and the state of kneading massage, so that sometimes the distance between the left and right facing massage balls is not fixed.

The present invention is to solve the above problems, and its object is to provide a massage machine in which the massage balls have a large moving range, making it possible to give greater massage feeling to a person to be treated, while at the same time, the distance between the left and right facing massage balls can be adjusted securely.

To achieve the above-described object, the present invention provides a massage machine with massage balls to swing, which comprises: a drive shaft rotatably driven in forward and reverse directions; a pair of inclined shafts mounted on both ends of the drive shaft so as to have an arbitrary inclination relative to an axial direction of the drive shaft; a pair of left and right massage ball units including the massage balls and rotatably connected to outer peripheral surfaces of the pair of inclined shafts, respectively; and switching means for switching an axial rotation position of one inclined shaft of the pair of inclined shafts, wherein the massage ball units each comprise: a swing arm having one end rotatably connected to the outer peripheral surface of the inclined shaft; and a support arm connected to the other end of the swing arm and having mounted thereon the massage balls at a vertical distance from each other.

According to the present invention, the distance from the drive shaft to the massage balls is large because of the presence of the swing arms, while the moving range of the massage balls is large because the upper and lower massage balls mounted on each support arm move in the same direction, so that a person to be treated can have great massage feeling.

The switching means switches the axial rotation position of the inclined shaft by switching the rotation direction of the drive shaft, the inclined shaft being able to idle in approximately 180° relative to the drive shaft. Thus, it is possible to switch between the state of kneading massage and the state of swing massage by switching the rotation direction of the drive shaft. Further, it is preferable that an elastic body is used to apply pressure to the inclined shaft in the axial direction of the drive shaft. This enables to avoid a situation that the inclined shaft is forced to rotate e.g. due to a load applied to the swing arm by a person to be treated, because the inclined shaft is able to idle at the time of the above-described switching.

The massage machine according to the present invention further comprises distance adjusting means for stopping the rotation of the drive shaft at an arbitrary position so as to make it possible to adjust the distance between the pair of left and right massage ball units, wherein the distance adjusting means rotates the drive shaft at least one rotation when adjusting the distance between the massage ball units. The distance adjusting means allows the drive shaft to be always placed at a predetermined position relative to the drive shaft, so that a person to be treated can securely adjust the distance between the massage ball units.

The massage machine according to the present invention further comprises drive means for providing a further movement to the pair of left and right massage ball units without depending on the rotation and driving of the drive shaft, wherein the drive means drives the massage ball units after rotating the drive shaft in one direction. The further movement described above refers e.g. to a movement of the massage ball units in a direction vertical to the surface of a backrest of the massage machine as in the tapping massage, while the drive means described above refers to an independent drive means which is separate from driving means for driving the drive shaft. When the drive means described above allows the massage ball units to perform the further movement (e.g. tapping massage), the drive shaft is first rotated in a predetermined rotation direction. This allows the inclined shaft to be set at a predetermined axial rotation position relative to the drive shaft, so that the further movement can be performed securely.

It is preferable that the drive shaft be rotated at a maximum speed when the distance adjusting means operates. This is in order to make it possible to more securely switch the relationship of the axial rotation position of the inclined shaft which is able to idle relative to the drive shaft.

The both ends of the drive shaft have a pair of eccentric shaft members having an axial center at a position eccentric from the center of the rotational axis of the drive shaft, wherein the swing arms of the pair of left and right massage ball units are respectively connected to the eccentric shaft members via the inclined shafts. This allows the eccentric shaft members to rotate with the rotational axis of the drive shaft as a center, so that the swing arms connected to the eccentric shaft members can add movement vertical to the front side of the backrest of the massage machine.

It is preferable that the support arm can pivot up and down relative to the swing arm, and be spring-biased in an arbitrary direction. For example, when the direction of the spring bias is set at a direction vertical to the front side of the backrest of the massage machine, all the massage balls can be kept in a state of being in contact with the back of a person to be treated.

### BRIEF DESCRIPTION OF DRAWINGS

FIG. 1 is a side view for explaining up and down driven movement of a massage machine according to an embodiment of the present invention;

FIG. 2 is a perspective view of a massage mechanism of the massage machine;

FIG. 3 is a top plan view of the massage mechanism;

FIG. 4 is a front view of the massage mechanism;

FIG. 5 is a side view of the massage mechanism;

FIG. 6 is a rear view of the massage mechanism;

FIG. 7 is a side view of a massage ball unit and a connecting rod of the massage mechanism;

FIG. 8A is a front view, FIG. 8B is a left side view and FIG. 8C is a right side view showing a drive shaft and inclined shafts of the massage mechanism;

FIGS. 9A and 9B are views for explaining movements of the same;

FIG. 10A is a front view, FIG. 10B is a left side view and FIG. 10C is a right side view showing a further state of the drive shaft and the inclined shafts of the same;

FIGS. 11A and 11B are views for explaining movements of the same;

FIG. 12 is a view showing movement of the massage ball unit based on the rotation of an eccentric shaft member with the drive shaft as an axial center;

FIG. 13 is a view for explaining a structure of an inclined shaft to which a pressure is applied by using an elastic body;

FIGS. 14A and 14B are views showing a structure of a drive shaft and inclined shafts with a clutch mechanism; and

FIGS. 15A to 15D are view for explaining movements of massage balls according to a conventional massage mechanism.

### BEST MODE FOR CARRYING OUT THE INVENTION

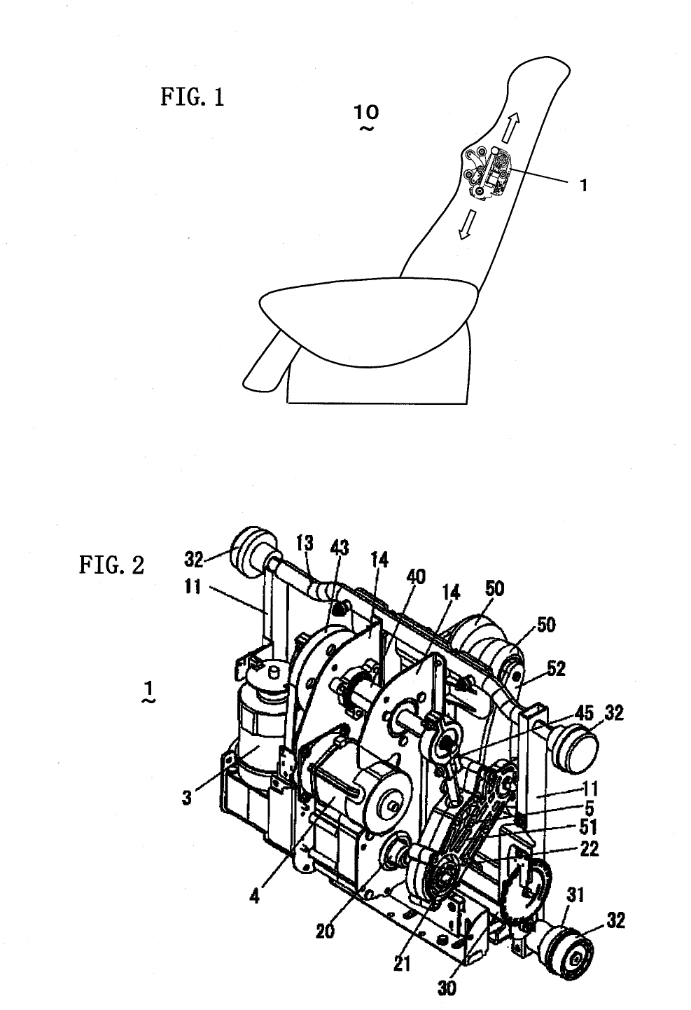

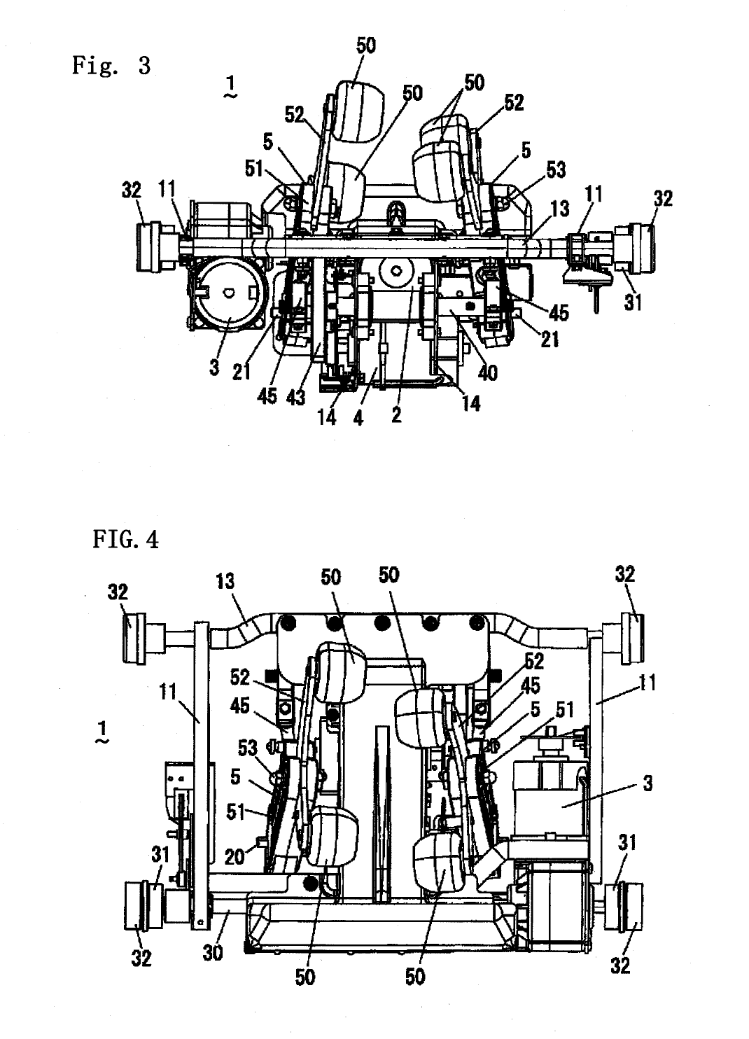

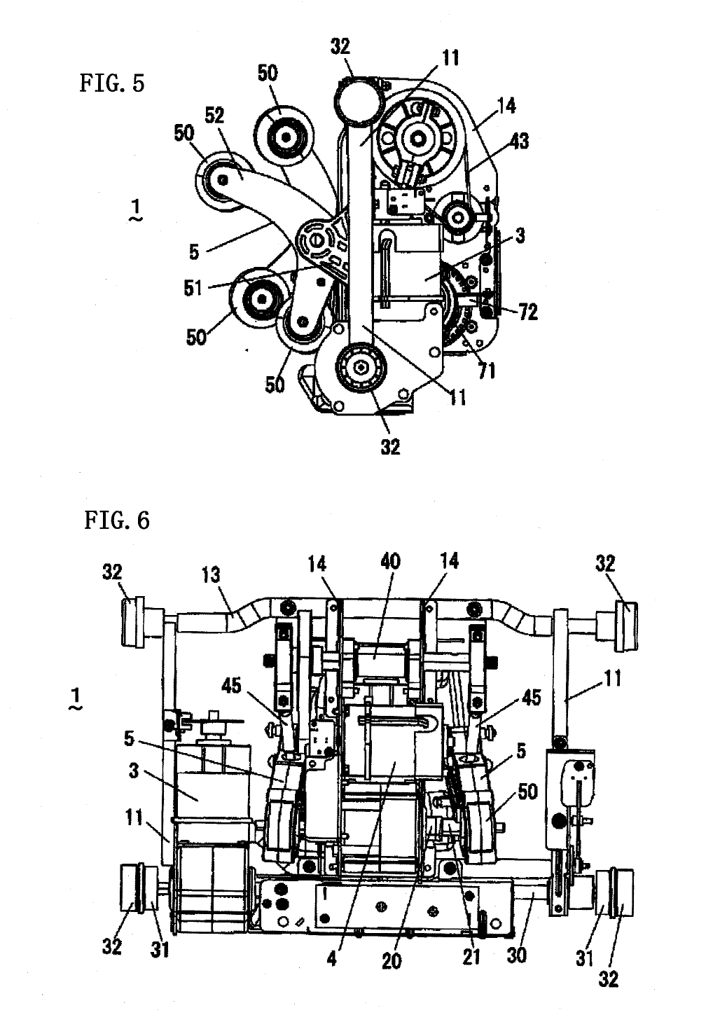

A massage machine according to an embodiment of the present invention will be described with reference to the drawings. As shown in FIG. 1, a massage machine 10 according to the present embodiment comprises a massage mechanism 1 arranged to autonomously move up and down in a backrest of a chair. As shown in FIGS. 1 to 6, the massage mechanism 1 is formed of a kneading drive motor unit 2 (refer to FIG. 3), an up-and-down drive motor unit 3, a tapping drive motor unit 4, a pair of left and right massage ball units 5, and so on, which are mounted in a frame formed of: a pair of left and right positioned vertical frame members 11; a guide shaft 13 connecting upper ends of the pair of vertical frame members 11; a moving shaft 30 disposed between lower ends of the vertical frame members 11; a pair of mounting plates 14 placed midway on the guide shaft 13; and so on. Note that FIG. 5 shows a slit plate 71 for moving position detection and a photosensor 72 for moving position detection described later.

The moving shaft 30 has a pair of pinions 31 fixed at both ends thereof. These pinions 31 have rotatable guide rollers 32 respectively mounted thereon. Further, the guide shaft 13 also has guide rollers 32 mounted at both ends thereof. The pinions 31 mesh with a rack (not shown) attached to guide rails, while the guide rollers 32 roll and move on the guide rails (not shown) placed left and right in the backrest of the massage machine 10. Further, the up-and-down drive motor unit 3 rotates and drives the moving shaft 30 with the pinions 31, whereby the massage mechanism 1 moves freely up and down along the guide rails in the backrest of the massage machine.

The rotational power from the kneading drive motor unit 2 is transmitted to a drive shaft 20 placed at a lower portion of the mounting plates 14. As shown in FIG. 8A, the drive shaft 20 has both ends respectively connected to eccentric shaft members 21 each having an axial center at a position eccentric from the center of the rotational axis of the drive shaft 20. Further, the respective eccentric shaft members 21 each have an outer periphery on which inclined shafts 22a and 22b are placed, respectively, as shown in FIGS. 8B and 8C. These inclined shafts 22a and 22b each have a notch portion extending along substantially half of its circumference. The eccentric shaft member 21 with the one inclined shaft 22a placed thereon has a through pin 23 passing through the eccentric shaft member 21. Both end portions of this through pin 23 extend from the eccentric shaft member 21. Thus, when the drive shaft 20 rotates, the inclined shaft 22a is engaged with the eccentric shaft member 21 by the through pin 23 so as to rotate with the drive shaft 20. Further, the eccentric shaft member 21 with the other inclined shaft 22b placed thereon has a stopper pin 24 passing through the eccentric shaft member 21. Only one end portion of this stopper pin 24 extends from the eccentric shaft member 21. Thus, when the drive shaft 20 rotates in a forward direction, the inclined shaft 22b is engaged with the eccentric shaft member 21 by the stopper pin 24 so as to rotate with the drive shaft 20. On the other hand, when the drive shaft 20 rotates in a reverse direction, the inclined shaft 22b is released from engagement with the eccentric shaft member 21 by the notch portion thereof so as to idle for approximately 180° relative to the drive shaft 20.

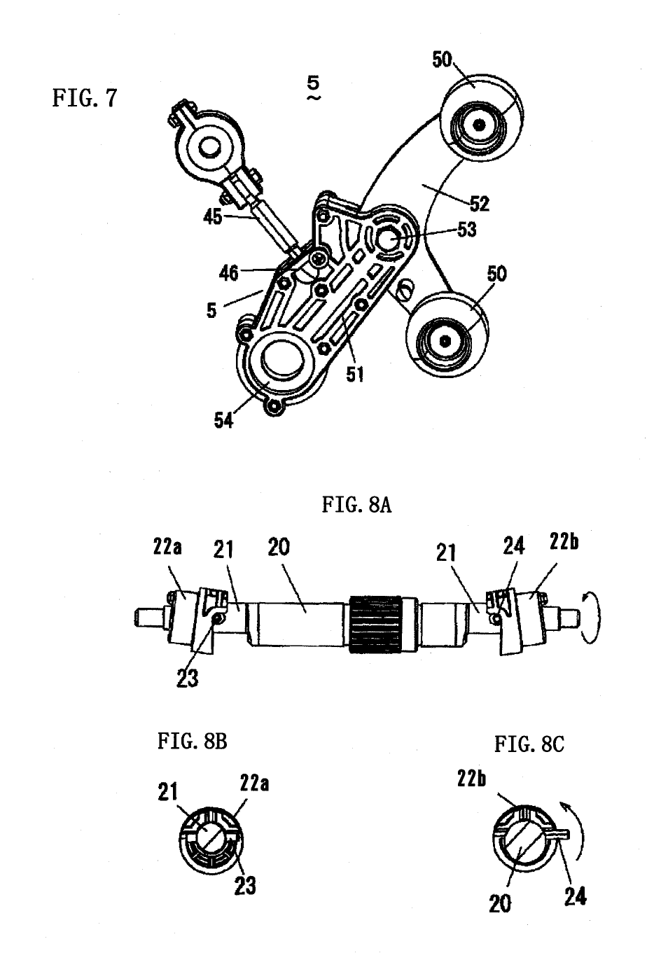

The massage ball units 5 are respectively connected to the inclined shafts 22a and 22b. As shown in FIG. 7, these massage ball units 5 are each formed of a swing arm 51 connected to the inclined shaft 22 and a support arm 52 having a pair of upper and lower roller-shaped massage balls 50 mounted thereon. The swing arm 51 is connected to an outer periphery of the inclined shaft 22 via a bearing 53 so as to rotate with the rotation of the inclined shaft 22. The support arm 52 has a V-shaped side view, and is rotatably connected at its central portion to the swing arm 51 by a shaft 53, and further has both ends with the two massage balls 50 mounted at a vertical distance from each other. The support arm 52 is spring-biased in a direction to allow the upper massage ball 50 to project out to the front side of the backrest.

Furthermore, a tapping drive shaft 40 is provided at an upper portion of the pair of mounting plates 14 (refer to FIG. 2 and FIG. 6). The rotational power of the tapping drive motor unit 4 is transmitted to the tapping drive shaft 40 via a belt 43. This tapping drive shaft 40 has crank shafts formed at its both ends and each having an eccentric shaft member (not shown). Further, these eccentric shaft members are connected to the swing arms 51 of both massage ball units 5 by connecting rods 45, respectively. The tapping drive shaft 40 and the connecting rods 45 are related so that the connecting rods 45 can rotate around the axis of the tapping drive shaft 40 and can also swing in the axial direction of the tapping drive shaft 40. In addition, each connecting rod 45 is connected to the swing arm 51 of the massage ball unit 5 via a three-dimensionally movable joint 46 (refer to FIG. 7).

As described above, the massage mechanism 1 is driven by the up-and-down drive motor unit 3 to autonomously move up and down in the backrest so as to change the positions of the massage balls 50 up and down. Here, the support arm 52 having the pair of upper and lower massage balls 50 mounted thereon can pivot up and down, with the shaft 53 as an axis, relative to the swing arm 51 (refer to FIG. 7), and is spring-biased so that the pair of upper and lower massage balls 50 is always in a state of being in contact with the back of a person to be treated who leans against the surface of the backrest of the massage machine 10.

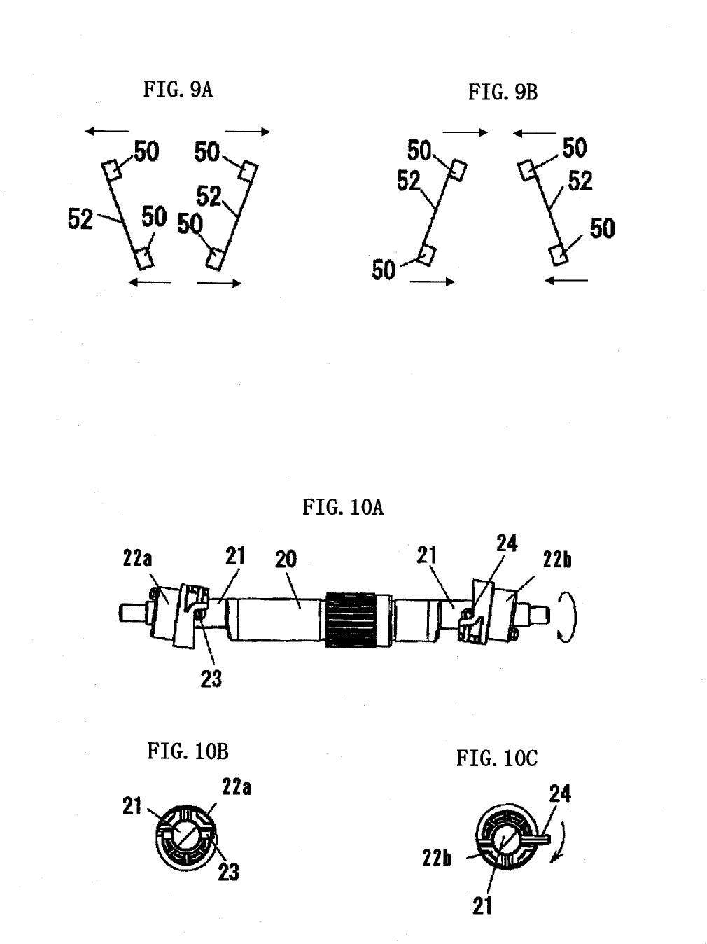

When the rotation direction of the kneading drive motor unit 2 is the forward direction, the inclination directions of the inclined shafts 22a and 22b respectively placed on the eccentric shaft members 21 at both ends of the drive shaft 20 are opposite to each other as shown in FIGS. 8A to 8C. Thus, the pair of left and right massage ball units 5 connected to the respective inclined shafts 22a and 22b can operate to allow the support arms 52 of the respective massage ball units 5 to get closer to or farther from each other as shown in FIGS. 9A and 9B. Further, the massage ball unit 5 has the connecting rod 45 limiting the movement of the swing arm 51 to a predetermined range. Accordingly, by adjusting the connection angles of the crank shafts formed at both ends of the tapping drive shaft 40, it becomes possible to make the distance between the upper massage balls 50 longer while making the distance between the lower massage balls 50 shorter as shown in FIG. 9A, or to make the distance between the upper massage balls 50 shorter while making the distance between the lower massage balls 50 longer as shown in FIG. 9B.

Further, the pair of eccentric shaft members 21 to be engaged with the inclined shafts 22a and 22b have an axial center at a position eccentric from the center of the rotational axis of the drive shaft 20, so that the rotation of the drive shaft 20 causes the position of the central axis of the eccentric shaft members 21 to rotate. As a result, as shown in FIG. 12, the massage balls 50 can move vertically relative to the surface of the backrest of the massage machine 10. That is, the massage mechanism 1 according to the present embodiment allows the massage balls 50 to move as shown in FIGS. 9A and 9B and FIG. 12, making it possible to give a kneading massage to the back of a person to be treated.

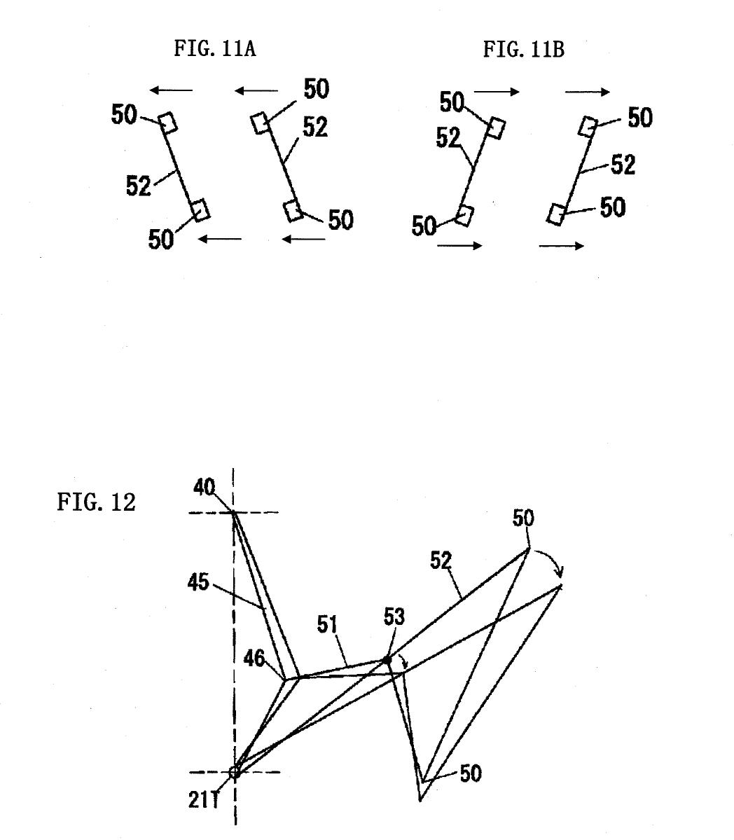

When the rotation direction of the kneading drive motor unit 2 is the reverse direction, one inclined shaft 22a rotates with the drive shaft 20, whereas the other inclined shaft 22b idles in approximately 180° relative to the drive shaft 20, so that the axial rotation position of the inclined shaft 22b relative to the inclined shaft 22a changes by approximately 180°. As a result, as shown in FIG. 10, the inclinations of the axes of the two inclined shafts 22a and 22b are switched to the same direction (switching means). Thus, as shown in FIG. 11, the pair of left and right massage ball units 5 connected to these inclined shafts 22a and 22b move and swing left and right in the same direction with the support arms 52 being arranged parallel. That is, the massage mechanism 1 according to the present embodiment can perform swing massage so that the back of a person to be treated is much shaken alternately left and right.

In the massage mechanism 1 of the present embodiment, the support arms 52 having the massage balls 50 mounted thereon are not directly connected to the inclined shafts 22a and 22b, but are connected thereto via the swing arms 51. Thus, as to the movements of the massage ball units 5, which depend on the rotational power of the kneading drive motor unit 2, the moving directions of the respective massage balls 50 placed up and down on each support arm 52 are the same when performing the movements shown in FIG. 9 as well as when performing the movements shown in FIG. 11.

In particular, as shown in FIG. 10 and FIG. 11, when the inclination directions of the pair of left and right massage ball units 5 are switched to the same state, all the massage balls 50 mounted on the massage ball units 5 move and swing in the same direction. Thus, the back of a person to be treated which contacts these massage balls 50 is much shaken left and right, so that the person to be treated can have great massage feeling.

Furthermore, when the tapping drive shaft 40 is rotated by the tapping drive motor unit 4, the connecting rods 45 swing the swing arms 51 up and down, whereby the massage balls 50 perform a continuous vertical movement to give a tapping massage to the person to be treated.

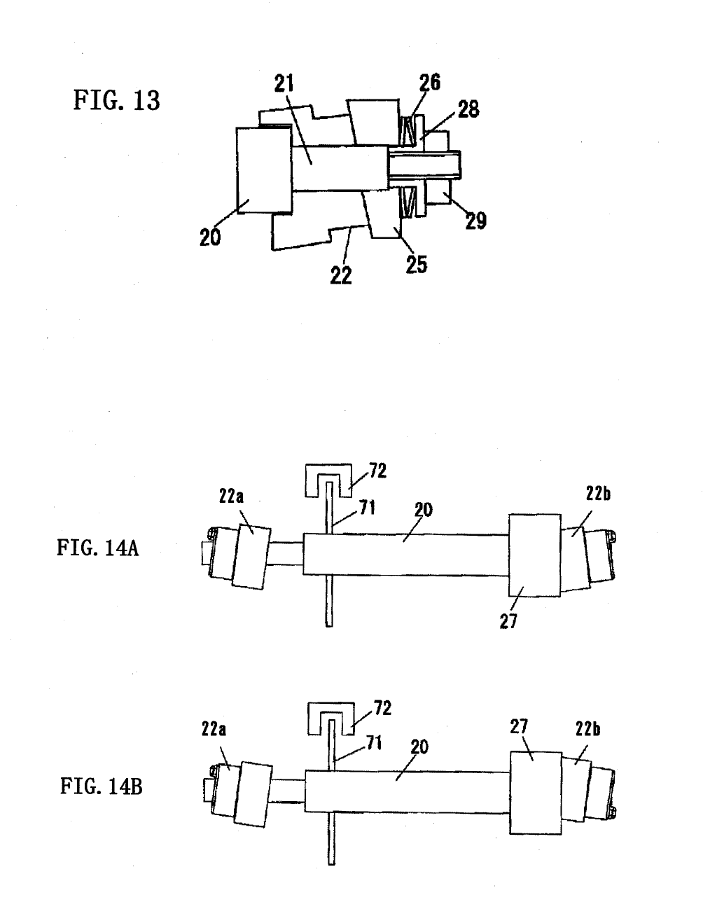

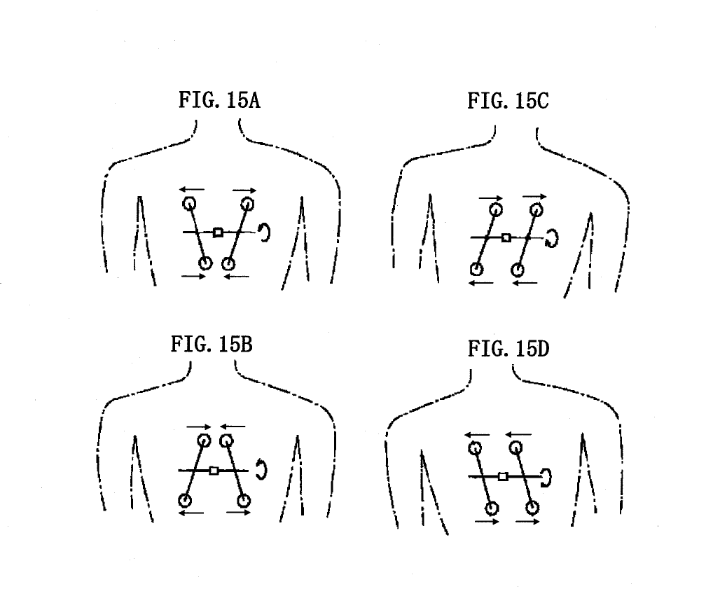

When the kneading massage shown in FIG. 9 and the swing massage shown in FIG. 11 are switched between each other by changing the rotation direction of the drive shaft 20, it is preferable as shown in FIG. 13 to use an elastic body 26 made of a disc spring to apply pressure in the axial direction of the drive shaft 20 to the inclined shaft 22b which is able to idle for half circumference relative to the drive shaft 20 by being engaged with the stopper pin 24. Note that FIG. 13 shows an inclined plate 25, a bearing tube 28 and a fixing nut 29 which are used for the application of pressure based on the elastic body 26.

The above-described pressure causes gentle braking to be applied to the rotation of the inclined shaft 22b relative to the drive shaft 20, and prevents the inclined shaft 22b from rotating prior to the drive shaft 20 (stopper pin 24), so that the pair of left and right massage ball units 5 can be always kept in a state of synchronous movement.

Furthermore, as shown in FIG. 14, an electromagnetic clutch 27 to separate the connection of the inclined shaft 22b at the time of switching the rotation direction of the drive shaft 20 can be used to switch the rotation direction of the inclined shaft 22b relative to the shaft 20. Note that a description of the structure of the electromagnetic clutch 27 is omitted.

Next, referring to the drawings, which are the same as those of the above-described embodiment, a massage machine according to another embodiment of the present invention will be described. In the massage machine 10 according to the above-described embodiment, when the inclined shafts 22a and 22b are stopped at an arbitrary position while the drive shaft 20 rotates in a forward direction, it is possible to adjust the distance between the pair of left and right massage ball units 5. However, while the drive shaft is rotated in a reverse direction, and the inclined shaft 22b is allowed to idle in approximately 180° relative to the drive shaft 20 so as to change the respective inclination directions of the inclined shafts 22a and 22b, the massage ball unit 5 connected to the inclined shaft 22b is not driven, resulting in that the distance between the pair of left and right massage ball units 5 is not fixed. Thus, as shown in FIG. 4 (sic, correctly: FIG. 5), the massage machine 10 according to this embodiment detects the rotation position of the drive shaft 20 by providing a slit plate 71 and a photosensor 72, and stops the drive shaft 20 at an arbitrary rotation position, so as to make it possible to adjust the distance between the pair of left and right massage ball units 5 to an arbitrary width (distance adjusting means). In adjusting this distance, a control circuit (not shown) for controlling the above-described kneading drive motor unit 2, the tapping drive motor unit 4 and the massage ball units 5 rotates the drive shaft 20 at least one rotation, and thereafter stops it at an arbitrary rotation position.

When the drive shaft 20 is rotated at least one rotation at the time of the distance adjustment as described above, the massage balls 50 project much forward to pass through a state in which a load of a human body becomes maximum, so that the inclined shaft 22b is set at a predetermined axial rotation position relative to the drive shaft 20. Accordingly, the range in which the inclined shaft 22b is able to idle does not affect the above-described distance adjustment, allowing the distance adjustment between the pair of left and right massage ball units 5 to be made securely.

When the state of kneading massage shown in FIG. 9 is switched to the tapping massage by operating the tapping drive motor unit 4 (claimed drive means for providing a further movement), the drive shaft 20 is stopped at an arbitrary position to allow a change to the tapping massage while making the distance adjustment between the pair of left and right massage ball units 5. However, when the state of swing massage shown in FIG. 11 is switched to the tapping massage, the distance between the massage ball units 5 does not change because the tapping drive motor unit 4 does not drive the drive shaft 20, making it impossible to directly adjust the distance between the massage ball units 5 to a width suitable for the tapping massage.

However, when the above-described control circuit controls the rotation direction of the drive shaft 20 to drive the drive shaft 20 rotating in a reverse direction to rotate in a forward direction so as to switch the state to the kneading massage, and thereafter to the tapping massage, it becomes possible that a person to be treated can securely adjust the distance between the massage ball units 5.

Note that the massage machine of the present embodiment is preferably designed to switch to the state of kneading massage in a similar manner as described above also when moving the massage mechanism 1 up and down so as to allow the massage balls 50 to move and rub the back of a person to be treated.

Further, when the above control circuit rotates the drive shaft 20 at a maximum speed at the time of adjusting the distance between the massage ball units 5 or switching the massage, it becomes possible to more securely switch the relationship of the axial rotation position of the inclined shaft 22b, which is able to idle in approximately 180°, relative to the drive shaft 20.

The present application is based on Japanese Patent Applications 2005-219481 and 2005-219482, the contents of the patent applications being incorporated into the present application by reference.

1. A massage machine with massage balls to swing, the massage machine comprising:
a drive shaft rotatably driven in forward and reverse directions;
a pair of inclined shafts mounted on both ends of the drive shaft so as to have an arbitrary inclination relative to an axial direction of the drive shaft;
a pair of left and right massage ball units including the massage balls and rotatably connected to outer peripheral surfaces of the pair of inclined shafts, respectively; and
switching means for switching an axial rotation position of one inclined shaft of the pair of inclined shafts,
wherein the massage ball units each comprise: a swing arm having one end rotatably connected to the outer peripheral surface of the inclined shaft; and a support arm connected to the other end of the swing arm and having mounted thereon the massage balls at a vertical distance from each other.

2. The massage machine according to claim 1, wherein the switching means switches the axial rotation position of the inclined shaft by switching the rotation direction of the drive shaft, the inclined shaft being able to idle in approximately 180° relative to the drive shaft.

3. The massage machine according to claim 2, which further comprises distance adjusting means for stopping the rotation of the drive shaft at an arbitrary position so as to make it possible to adjust the distance between the pair of left and right massage ball units,
wherein the distance adjusting means rotates the drive shaft at least one rotation when adjusting the distance between the massage ball units.

4. The massage machine according to claim 3, wherein the drive shaft is rotated at a maximum speed when the distance adjusting means operates.

5. The massage machine according to claim 2, which further comprises drive means for providing a further movement to the pair of left and right massage ball units without depending on the rotation and driving of the drive shaft,
wherein the drive means drives the massage ball units after rotating the drive shaft in one direction.

6. The massage machine according to claim 5, wherein the drive shaft is rotated at a maximum speed when the distance adjusting means operates.

7. The massage machine according to claim 1, wherein the both ends of the drive shaft have a pair of eccentric shaft members having an axial center at a position eccentric from the center of the rotational axis of the drive shaft, and
wherein the swing arms of the pair of left and right massage ball units are respectively connected to the eccentric shaft members via the inclined shafts.

8. The massage machine according to claim 1, wherein the support arm can pivot up and down relative to the swing arm, and is spring-biased in an arbitrary direction.

9. The massage machine according to claim 1, wherein an elastic body is used to apply pressure to the inclined shaft in the axial direction of the drive shaft.
